(19) United States
(12) Patent Application Publication
(10) Pub. No.: US 2007/0055576 A1
(43) Pub. Date: Mar. 8, 2007

(54) Procurement Matching

(76) Inventor: Mark Wayman, Oakland, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/463,568

(22) Filed: Aug. 9, 2006

Related U.S. Application Data
(60) Provisional application No. 60/715,550, filed on Sep. 8, 2005.

(51) Int. Cl. G06Q 30/00

(52) U.S. Cl. 705/26

(57) ABSTRACT

There is disclosed procurement matching apparatus and methods. Procurement requests may be recorded which include a description of goods or services desired for procurement, a category of the desired goods or services, and an identity of a requester of the desired goods or services. Procurement search criteria may be received. The procurement search criteria may include a category selected from a two-level hierarchy of categories. Procurement request records may be identified which match the procurement search criteria and a report of the identified procurement request records generated. The categories may be selected from a subset of the North American Industry Classification System (NAICS).

### RELATED APPLICATION INFORMATION

This patent claims priority from Application No. 60/715,550 filed Sep. 8, 2005, which is incorporated herein by reference.

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to procurement matching.

2. Description of the Related Art

Procurement matching systems have been proposed and implemented in the past. Procurement involves entities purchasing or otherwise acquiring goods and services. These entities, which will be referred to herein as “requesters”, are typically government agencies and large corporations. Requestors typically publish their procurement needs and interests (“requests”). In procurement matching, businesses interested in selling goods (“offerors”) are aided in finding the requests. Both the requesters and offerors may be represented by people acting on behalf of the requester or offeror, though for the purposes of this patent, this distinction is not relevant.

Typically, procurement matching focus on a single large corporate or government entity. To make a match, there must be a fit between the capabilities of the offeror and the substance of the request.

Procurement matching systems have included schemes for categorizing the goods and services requested and offered. By category, it is meant a distinct division within a system of classification to which entities may belong. Numerous systems exist for categorizing goods, services and industries. Some of these systems are supply-side oriented and others are demand-side oriented.

One system of categories is the North American Industry Classification System (NAICS). The NAICS was developed jointly by the U.S., Canada, and Mexico to provide comparability in statistics about business activity across North America and replaces the older Standard Industrial Classification (SIC) system. The NAICS includes hierarchical definitions for each industry and corresponding codes. Establishments are grouped together into industries based on the production processes used to produce a good or service. Information about NAICS is available at naics.com, ntis.gov and census.gov.

NAICS industries are identified by a 6-digit code, in contrast to the 4-digit SIC code. The longer code accommodates the larger number of categories and allows more flexibility in designating subcategories. It also provides for additional detail not necessarily appropriate for all three NAICS countries. The international NAICS agreement fixes only the first five digits of the code. The sixth digit, where used, identifies subdivisions of NAICS industries that accommodate user needs in individual countries. Thus, 6-digit U.S. codes may differ from counterparts in Canada or Mexico, but at the 5-digit level they are standardized.

The NAICS hierarchy provides five levels of categorization, with categories assigned either a two, three, four, five or six-digit code. There is no categorization associated with one-digit codes. There are twenty major categories plus one catch-all “unclassified” category, each represented by a two-digit code:

11 Agriculture, Forestry, Fishing, and Hunting

21 Mining

22 Utilities

23 Construction

31-33 Manufacturing

42 Wholesale Trade

44-45 Retail Trade

48-49 Transportation and Warehousing

51 Information

52 Finance and Insurance

53 Real Estate and Rental and Leasing

54 Professional, Scientific, and Technical Services

55 Management of Companies and Enterprises

56 Administrative and Support, Waste Management and Remediation Services

61 Educational Services

62 Health Care and Social Assistance

71 Arts, Entertainment, and Recreation

72 Accommodation and Foodservices

81 Other Services

92 Public Administration

99 Unclassified

Lower levels, using increasing numbers of digits, also correspond to increasing detail in the subject industry. All told, NAICS presents a powerful array of choices in categorizing a good, service or industry.

The NAICS has been used in procurement matching systems. It is reported that the U.S. Federal government uses industry classifications for procurement purposes, both for classifying the procurement action and for procurement data reporting and analyses.

### DESCRIPTION OF THE DRAWINGS

FIG. 1 is a diagram of a procurement matching architecture.

FIG. 2 is a flow chart for procurement matching.

### DETAILED DESCRIPTION

Throughout this description, the embodiments and examples shown should be considered as exemplars, rather than limitations on the apparatus and methods disclosed or claimed.

Description of Apparatus

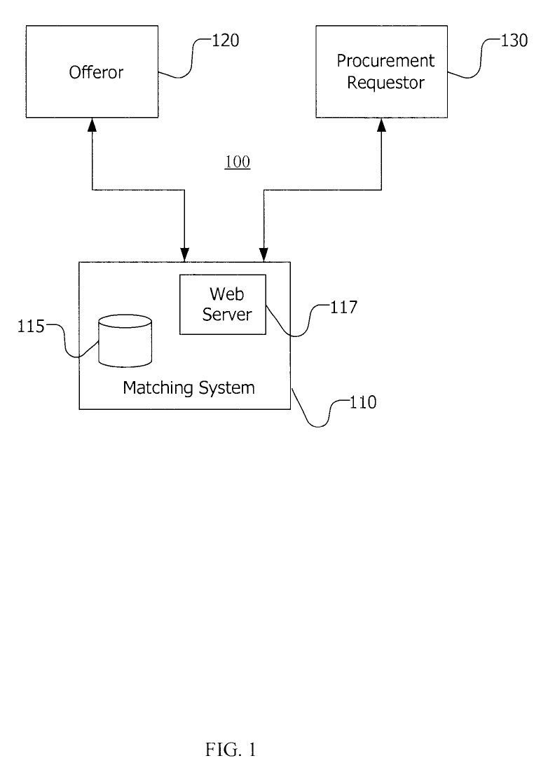

Referring now to FIG. 1 there is shown a diagram of a procurement matching architecture 100. The procurement matching architecture 100 includes a offeror system 120, a procurement requester system 130 and a matching system 110. The procurement matching architecture 100 is open to any number of offeror systems and procurement requester systems, but for simplicity of description only one of each are described herein. The offeror system 120, the procurement requester system 130 and the matching system 110 may each be general purpose computers adapted for networked communications. Through the architecture 100 shows direct connections between the offeror system 120, the procurement requester system 130 and the matching system 110, in practice they may be connected through a network such as the Internet.

The general purpose computers used for the offeror system 120, the procurement requester system 130 and the matching system 110 may include software and/or hardware for providing functionality and features described herein. A general purpose computer may therefore include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components of the general purpose computers may include various specialized units, circuits. software and interfaces for providing the functionality and features described here. The processes, functionality and features may be embodied in whole or in part in software which operates on a general purpose computer and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some components are performed by a client computer and others by other devices.

A general purpose computer as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run any operating system, including, for example, variations of the Linux, Unix, MS-DOS, Microsoft Windows, Palm OS, and Apple Mac OS X operating systems.

Additional and fewer units, modules or other arrangement of software, hardware and data structures may be used to achieve the processes and apparatuses described herein.

The offeror system 120 and the procurement requester system 130 may function as thin clients using, for example, a web browser to connect to the matching system 110. Users of the offeror system 120 and the procurement requester system 130 may navigate to the matching system to enter and retrieve data.

The matching system 110 may include a web server 117 and a database 115. The web server 117 acts as an interface to the offeror system 120 and the procurement requester system 130. The database 115 is a repository for procurement request records from the procurement requester system 130, and supports searches from the offeror system 120. Additional functionality is described below.

Description of Processes

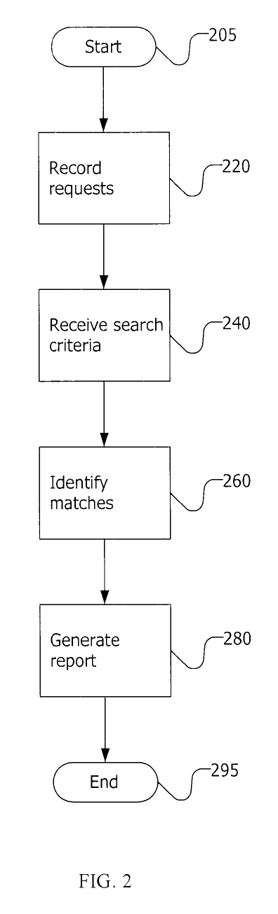

Referring now to FIG. 2 there is shown a flow chart for procurement matching. The process is described from the perspective of the matching system 110 (FIG. 1), though it is compatible with other devices and architectures. The flow chart has both a start 205 and an end 295, but the process is cyclical in nature and the ordering of the steps is not necessarily critical.

In one step (step 220), the matching system receives and records procurement requests. These requests may be made by a requester using the procurement requester system 130 (FIG. 1), and accessing the matching system through a web interface. Through this interface, the requester may enter various information to be included in the procurement request records. The procurement request records may include a number of fields which directly or indirectly store information from the requester. These fields may include a description of and/or keywords for the goods or services desired for procurement, a category (or industry) of the desired goods or services or provider of those goods or services, and an identity of a requester of the desired goods or services. The identity may be text and/or a code.

Other fields and data may be included or associated with a procurement request record. These fields may include a title for the request (or contract or RFP, as the case may be), the name of a contact and their contact information, a date for opening or publishing the request, a date and time for closing the request, a budget or value expressed as a single amount or a range, a location of where the goods or services are to be delivered, any special requirements for the request, and any licenses required to fulfill the request. In addition, the requester may be permitted to upload documents related to the request.

The requester may be permitted to restrict offerors to or from certain countries, states or other designated areas. Other restrictions regarding publication and/or bidding may be permitted as to types of businesses. One restriction may be to minority business enterprises, such as African-American, Asian-Indian American, Asian-Pacific American, Hispanic, and/or Native American. Other restrictions may be to HUBZone Small Business Concern (HUBZone), Small Business Concern (SB), Small Disadvantaged Business (SDB), Veteran-Owned Small Business (VOSB), Disabled Veteran-Owned Small Business (DVOSB), Woman Business Enterprise (WBE), and/or Women-Owned Small Business (WOSB).

Sometimes, conferences are associated with procurement activities, and data relating to a conference may be included in the procurement request records. This data may include title of the conference (e.g., “pre-bid meeting”), a meeting summary, data and time for the meeting, location and address.

Although in this description it is assumed that there is a one-to-one correspondence between requests and request records, this is not required. Each request may be stored as a number of records, and multiple requests may be stored in a single record.

In another step (step 240), the matching system receives procurement search criteria from the offeror system 120 (FIG. 1). Procurement searches may be of various kinds. In one kind of search (“on-demand”), an offeror desires a match with existing records. In a second kind of search, an offeror desires notification when procurement requests of interest are recorded (“notification”). Depending on the kind of search, the search criteria may be more or less restrictive.

The search criteria may be just one category. Indeed, category alone may be a sufficient search criterion. However, it may be desirable to allow the offeror to select more than one category. The fields used in the procurement request records may also be used by the matching system, and the offeror allowed to enter corresponding search criteria for them. Some or all of the search criteria may be selected from pull down lists, check boxes or other types of input fields. Some fields may be treated differently in search and recordation. For example, while in recordation it may be desirable to receive a free-form description of the desired goods or services, in search it may be desirable to use keywords.

In another step (step 260), the matching system identifies procurement request records which match the procurement search criteria. For an on-demand search, this step 260 may be performed immediately after the matching system receives the offeror's search criteria. For a notification search, this step 260 may be performed periodically.

In another step (step 280), the matching system generates a report of the identified procurement request records. For an on-demand search, this step 280 may include the matching system generating a screen display to the offeror system. For a notification search, this step 280 may include the matching system sending an email message to an email address designated by the offeror.

Categories

Although many systems of categorization are compatible with the apparatus and methods described above, one has been developed which is particularly well-suited. It has been found that in procurement matching, the full NAICS list is, in general, too long from a usability standpoint. Furthermore, the NAICS list, or even any one selected level, does not directly lend itself for use in procurement matching.

According to one system of categorization, there is a two-level hierarchy of categories. The top level and second level categories are both selected from the North American Industry Classification System (NAICS). The top level includes all of the NAICS top-level categories. The second level of categories, however, is considerably shorter than all sub-levels in the NAICS. In the second level, for each top-level category, there is a subset of the lower-level NAICS categories. One limitation on sub-categories is to select just one of the lower NAICS levels. The selection of which lower NAICS level to use for the second level may be made separately for each top-level category. Furthermore, for each second level, the categories may be a subset of those available in the selected lower NAICS level. In this way, the hierarchy may be adapted for beneficial effect in its use in procurement matching.

In the procurement matching process described above, the category for a request record may be selected by the requester. Likewise, the category of the search may be selected by the offeror. Alternatively, the matching system may select or recommend one or more categories. The categories may be displayed as text, as a numeric code, or both. According to one display format, all of the categories are displayed to the users as text only, the top level categories are in reverse colors and all upper case, and the second level categories are in normal colors and in title case.

Although the paradigm of the matching system has been described as procurement request records which are searched by potential offerors, the converse is also possible. That is, potential offerors may enter records which identify the goods or services they vend, and procurement requesters can enter searches. Indeed, the two models are mutually compatible and may therefore be included in the same system or provided in conjunction with one another.

There are many possible ways of configuring a two-level hierarchy of categories from the NAICS as described above. One of these is set forth below.

11 Agriculture, Forestry, Fishing & Hunting

111 Crop Production

112 Animal Production

113 Forestry & Logging

114 Fishing, Hunting & Trapping

115 Support Activities for Agriculture & Forestry

21 Mining

211 Oil & Gas Extraction

212 Mining (except Oil & Gas)

213 Support Activities for Mining

22 Utilities

2211 Electric Power Generation, Transmission & Dist.

2212 Natural Gas Distribution

2213 Water, Sewage & Other Systems

23 Construction

2361 Residential Building Construction

2362 Nonresidential Building Construction

2371 Utility System Construction

2372 Land Subdivision

2373 Highway, Street, & Bridge Construction

2379 Other Heavy & Civil Engineering Construction

2381 Foundation, Structure, & Building Ext. Contractors

2382 Building Equipment Contractors

2383 Building Finishing Contractors

2389 Other Specialty Trade Contractors

31-33 Manufacturing

311 Food Manufacturing

312 Beverage & Tobacco Product Manufacturing

313 Textile Mills

314 Textile Product Mills

315 Apparel Manufacturing

316 Leather & Allied Product Manufacturing

321 Wood Product Manufacturing

322 Paper Manufacturing

323 Printing & Related Support Activities

324 Petroleum & Coal Products Manufacturing

325 Chemical Manufacturing

326 Plastics & Rubber Products Manufacturing

327 Nonmetallic Mineral Product Manufacturing

331 Primary Metal Manufacturing

332 Fabricated Metal Product Manufacturing

333 Machinery Manufacturing

334 Computer & Electronic Product Manufacturing

335 Electrical Equip., Appliance, & Component Manufacturing

336 Transportation Equipment Manufacturing

337 Furniture & Related Product Manufacturing

339 Miscellaneous Manufacturing

42 Wholesale Trade

423 Merchant Wholesalers, Durable Goods

424 Merchant Wholesalers, Nondurable Goods

425 Wholesale Electronic Markets & Agents & Brokers

44-45 Retail Trade

441 Motor Vehicle & Parts Dealers

442 Furniture & Home Furnishings Stores

443 Electronics & Appliance Stores

444 Building Material & Garden Equip. & Supplies Dlrs

445 Food & Beverage Stores

446 Health & Personal Care Stores

447 Gasoline Stations

448 Clothing & Clothing Accessories Stores

451 Sporting Goods, Hobby, Book, & Music Stores

452 General Merchandise Stores

453 Miscellaneous Store Retailers

454 Nonstore Retailers

48-49 Transportation & Warehousing

481 Air Transportation

482 Rail Transportation

483 Water Transportation

484 Truck Transportation

485 Transit & Ground Passenger Transportation

486 Pipeline Transportation

487 Scenic & Sightseeing Transportation

488 Support Activities for Transportation

491 Postal Service

492 Couriers & Messengers

493 Warehousing & Storage

51 Information

5111 Newspaper, Periodical, Book, & Directory Publshrs

5112 Software Publishers

5121 Motion Picture & Video Industries

5122 Sound Recording Industries

5151 Radio & Television Broadcasting

5152 Cable & Other Subscription Programming

5161 Internet Publishing & Broadcasting

5171 Wired Telecommunications Carriers

5172 Wireless Telecommunications Carriers

5173 Telecommunications Resellers

5174 Satellite Telecommunications

5175 Cable & Other Program Distribution

5179 Other Telecommunications

5181 Internet Service Providers & Web Search Portals

5182 Data Processing, Hosting, & Related Services

5191 Other Information Services

52 Finance & Insurance

521 Monetary Authorities—Central Bank

522 Credit Intermediation & Related Activities

523 Securities, Cmdty Ctrcts & Other Finl. Investments

524 Insurance Carriers & Related Activities

525 Funds, Trusts, & Other Financial Vehicles

53 Real Estate & Rental & Leasing

531 Real Estate

532 Rental & Leasing Services

533 Lessors of Nonfinancial Intangible Assets

54 Professional, Scientific, & Technical Services

5411 Legal Services

5412 Accounting, Tax Prep., Bookkeeping, & Payroll Svcs

5413 Architectural, Engineering, & Related Services

5414 Specialized Design Services

5415 Computer Systems Design & Related Services

5416 Management, Scientific & Technical Consulting Svcs

5417 Scientific Research & Development Services

5418 Advertising & Related Services

5419 Other Professional, Scientific, & Technical Svcs

55 Management of Companies & Enterprises

551111 Offices of Bank Holding Companies

551112 Offices of Other Holding Companies

551114 Corporate, Subsidiary, & Regional Managing Offices

56 Admin. & Support & Waste Mgmnt & Remediation Svcs

5611 Office Administrative Services

5612 Facilities Support Services

5613 Employment Services

5614 Business Support Services

5615 Travel Arrangement & Reservation Services

5616 Investigation & Security Services

5617 Services to Buildings & Dwellings

5619 Other Support Services

5621 Waste Collection

5622 Waste Treatment & Disposal

5629 Remediation & Other Waste Management Services

61 Educational Services

6111 Elementary & Secondary Schools

6112 Junior Colleges

6113 Colleges, Universities, & Professional Schools

6114 Business Schools & Computer & Management Training

6115 Technical & Trade Schools

6116 Other Schools & Instruction

6117 Educational Support Services

62 Health Care & Social Assistance

6211 Offices of Physicians

6212 Offices of Dentists

6213 Offices of Other Health Practitioners

6214 Outpatient Care Centers

6215 Medical & Diagnostic Laboratories

6216 Home Health Care Services

6219 Other Ambulatory Health Care Services

6221 General Medical & Surgical Hospitals

6222 Psychiatric & Substance Abuse Hospitals

6223 Spclty (not Psychiatric/Substance Abuse) Hospitals

6231 Nursing Care Facilities

6232 Residential Mental Health & Subs. Abuse Facilities

6233 Community Care Facilities for the Elderly

6239 Other Residential Care Facilities

6241 Individual & Family Services

6242 Community Food/Housing/Emergency/Other Relief Svcs

6243 Vocational Rehabilitation Services

6244 Child Day Care Services

71 Arts, Entertainment, & Recreation

7111 Performing Arts Companies

7112 Spectator Sports

7113 Promoters of Perf. Arts, Sports, & Similar Events

7114 Agnts/Mgrs for Artists, Athletes, Ent. & Pub Figrs

7115 Independent Artists, Writers, & Performers

7121 Museums, Historical Sites, & Similar Institutions

7131 Amusement Parks & Arcades

7132 Gambling Industries

7139 Other Amusement & Recreation Industries

72 Accommodation & Food Services

7211 Traveler Accommodation

7212 RV Parks & Recreational Camps

7213 Rooming & Boarding Houses

7221 Full-Service Restaurants

7222 Limited-Service Eating Places

7223 Special Food Services

7224 Drinking Places (Alcoholic Beverages)

81 Other Services (except Public Administration)

8111 Automotive Repair & Maintenance

8112 Electronic & Precision Equip. Repair & Maintenance

8113 Commrcl & Ind. Machinery & Equip. Repair & Maint.

8114 Personal & Household Goods Repair & Maintenance

8121 Personal Care Services

8122 Death Care Services

8123 Drycleaning & Laundry Services

8129 Other Personal Services

813 Religious Organizations

8132 Grantmaking & Giving Services

8133 Social Advocacy Organizations

8134 Civic & Social Organizations

8139 Bus., Prof., Labor, Political, & Similar Org.

8141 Private Households

92 Public Administration

921 Executive, Legislative, & Other Gen. Gov. Support

922 Justice, Public Order, & Safety Activities

923 Administration of Human Resource Programs

924 Administration of Environmental Quality Programs

925 Admin. of Housing, Urban Planning & Community Dev.

926 Administration of Economic Programs

927 Space Research & Technology

928 National Security & International Affairs

It can be seen from this example that all of the top-level categories from the NAICS are used, but only selected lower levels. In each case, all of the second level categories in the example are themselves in the same NAICS level. However, the NAICS levels vary. Thus, for category 11 (Agriculture, Forestry, Fishing & Hunting) and category 21 (Mining), the second level categories are also second-level NAICS categories. In contrast, for category 22 (Utilities) and category 23 (Construction), the second level categories are third-level NAICS categories. In further contrast, for category 55 (Management of Companies and Enterprises), the second level categories are fifth-level NAICS categories. Thus, it can be seen that the second level categories may themselves be different NAICS levels, though all of the categories within a particular second-level are of the same NAICS level.

Closing Comments

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For any means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein. whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A system for procurement matching, the system comprising:
a processor
a memory coupled with the processor
a storage medium having instructions stored thereon which when executed cause the computing device to perform actions comprising
recording plural procurement requests each comprising a description of goods or services desired for procurement, a category of the desired goods or services, and an identity of a requester of the desired goods or services
receiving procurement search criteria comprising a category
identifying procurement request records which match the procurement search criteria
generating a report of the identified procurement request records
wherein the categories are selected from a two-level hierarchy of categories selected from the North American Industry Classification System (NAICS), the categories comprising
all of the NAICS top-level categories
for each top-level category, a subset of the lower-level NAICS categories for the top-level category, wherein the lower-level categories are all of the same NAICS level.

2. The system for procurement matching of claim 1. the actions further comprising,
periodically performing the identifying action, generating the report and sending an email message with the report to an offeror associated with the procurement search criteria.

3. The system for procurement matching of claim 1 wherein
the description of goods or services desired for procurement comprises keywords
the procurement search criteria include keywords.

4. The system for procurement matching of claim 1 wherein
the requesters choose the category of their requests.

5. The system for procurement matching of claim 1 further comprising additional fields for the procurement request records and the search criteria, the additional fields selected from the group comprising budget and location.

6. A process for procurement matching comprising
recording plural procurement requests each comprising a description of goods or services desired for procurement, a category of the desired goods or services, and an identity of a requester of the desired goods or services
receiving procurement search criteria comprising a category
identifying procurement request records which match the procurement search criteria
generating a report of the identified procurement request records
wherein the categories are selected from a two-level hierarchy of categories selected from the North American Industry Classification System (NAICS), the categories comprising
all of the NAICS top-level categories
for each top-level category, a subset of the tower-level NAICS categories for the top-level category, wherein the lower-level categories are all of the same NAICS level.

7. The process for procurement matching of claim 6 further comprising
periodically performing the identifying action, generating the report and sending an email message with the report to an offeror associated with the procurement search criteria.

8. The process for procurement matching of claim 6 wherein
the description of goods or services desired for procurement comprises keywords
the procurement search criteria include keywords.

9. The process for procurement matching of claim 6 wherein
the requesters choose the category of their requests.

10. The process for procurement matching of claim 6 further comprising additional fields for the procurement request records and the search criteria, the additional fields selected from the group comprising budget and location.

11. A storage medium having instructions stored thereon which when executed by a processor will cause the processor to perform actions comprising:
recording plural procurement requests each comprising a description of goods or services desired for procurement, a category of the desired goods or services, and an identity of a requester of the desired goods or services
receiving procurement search criteria comprising a category
identifying procurement request records which match the procurement search criteria
generating a report of the identified procurement request records
wherein the categories are selected from a two-level hierarchy of categories selected from the North American Industry Classification System (NAICS), the categories comprising
all of the NAICS top-level categories
for each top-level category, a subset of the lower-level NAICS categories for the top-level category, wherein the lower-level categories are all of the same NAICS level.

12. The storage medium of claim 11, the actions further comprising
periodically performing the identifying action, generating the report and sending an email message with the report to an offeror associated with the procurement search criteria.

13. The storage medium of claim 11 wherein
the description of goods or services desired for procurement comprises keywords
the procurement search criteria include keywords.

14. The storage medium of claim 11 wherein
the requesters choose the category of their requests.

15. The storage medium of claim 11 further comprising additional fields for the procurement request records and the search criteria, the additional fields selected from the group comprising budget and location.

16. A system for procurement matching. the system comprising:
means for recording plural procurement requests each comprising a description of goods or services desired for procurement, a category of the desired goods or services, and an identity of a requester of the desired goods or services
means for receiving procurement search criteria comprising a category
means for identifying procurement request records which match the procurement search criteria
means for generating a report of the identified procurement request records
wherein the categories are selected from a two-level hierarchy of categories selected from the North American Industry Classification System (NAICS), the categories comprising
all of the NAICS top-level categories
for each top-level category, a subset of the lower-level NAICS categories for the top-level category, wherein the lower-level categories are all of the same NAICS level.

17. The system for procurement matching of claim 16 further comprising
means for periodically performing the identifying action, generating the report and sending an email message with the report to an offeror associated with the procurement search criteria.

18. The system for procurement matching of claim 16 wherein
the description of goods or services desired for procurement comprises keywords
the procurement search criteria include keywords.

19. The system for procurement matching of claim 16 wherein
the requesters choose the category of their requests.

20. The system for procurement matching of claim 16 further comprising additional fields for the procurement request records and the search criteria, the additional fields selected from the group comprising budget and location.
